(19) United States
(12) Patent Application Publication
(10) Pub. No.: US 2026/0302891 A1
(43) Pub. Date: Oct. 1, 2026

(54) ELECTRIC MOTOR AND MOTOR DRIVE SYSTEM

(71) Applicant: HONDA MOTOR CO., LTD., Tokyo (JP)

(72) Inventor: Norikazu Kawai, Wako-shi (JP)

(21) Appl. No.: 19/630,808

(22) Filed: Mar. 27, 2026

(30) Foreign Application Priority Data
Mar. 31, 2025 (JP) 2025-058212

(51) Int. Cl. H02K 9/193; B64C 29/00; B64D 27/34; B64D 27/35; B64D 33/10; H02K 7/08; H02K 11/33; H02K 21/22

(52) U.S. Cl. CPC H02K 9/193; B64C 29/0016; B64D 27/34; B64D 27/35; B64D 33/10; H02K 7/085; H02K 11/33; H02K 21/22

(57) ABSTRACT

An electric motor includes an annular stator including a coil, a rotor including a plurality of magnets arranged to surround the outer periphery of the stator, an outer cylinder portion holding the plurality of magnets, and an inner cylinder portion located inward of the stator, and a heat exchanger that exchanges heat between coolant for cooling the coil of the stator and outside air. The heat exchanger is disposed between the stator and the inner cylinder portion of the rotor.

### CROSS-REFERENCE TO RELATED APPLICATIONS

This application is based upon and claims the benefit of priority from Japanese Patent Application No. 2025-058212 filed on Mar. 31, 2025, the contents of which are incorporated herein by reference.

### BACKGROUND OF THE INVENTION

### Field of the Invention

The present disclosure relates to an electric motor and a motor drive system.

### Description of the Related Art

US 2024/0116627 A1 discloses that in an electric vertical take-off and landing aircraft, a lift propeller generates a cooling air flow for cooling a lift motor.

### SUMMARY OF THE INVENTION

In a flying object such as an electric vertical take-off and landing aircraft, there is a need for a suitable electric motor and a suitable motor drive system.

The present disclosure has the object of satisfying the aforementioned need.

A first aspect of the present disclosure is an electric motor including: a stator having an annular shape and including a coil; a rotor including a plurality of magnets arranged to surround an outer periphery of the stator, an outer cylinder portion that holds the plurality of magnets, and an inner cylinder portion located inward of the stator; and a heat exchanger configured to exchange heat between outside air and coolant that cools the coil of the stator, wherein the heat exchanger is disposed between the stator and the inner cylinder portion of the rotor.

A second aspect of the present disclosure is a motor drive system including: the electric motor according to the first aspect; an inverter configured to convert direct-current power supplied from a power source into alternating-current power and supply the alternating-current power to the coil; a first partial flow path, wherein the coolant that has passed through the heat exchanger flows through the first partial flow path to thereby cool the inverter; and a second partial flow path, wherein the coolant that has passed through the first partial flow path flows through the second partial flow path to thereby cool the coil of the stator.

According to the present disclosure, a suitable electric motor and a suitable motor drive system can be provided.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic view of a flying object;

FIG. 2 is a side view of a VTOL rotor and drive unit;

FIG. 3 is a perspective view of a drive unit;

FIG. 4 is a vertical cross-sectional view of the drive unit;

FIG. 5 is a transverse cross-sectional view of the drive unit;

FIG. 6 is an enlarged view of a portion within frame F1 in FIG. 5;

FIG. 7 is an enlarged view of a portion within frame F2 in FIG. 5; and

FIG. 8 is a system configuration diagram of a motor drive system.

### DETAILED DESCRIPTION OF THE INVENTION

An electric vertical take-off and landing aircraft (also referred to as an eVTOL aircraft) includes a propeller that applies thrust to an airframe and an electric motor that rotates the propeller. The electric motor is cooled by a coolant such as a cooling liquid. In this case, the coolant absorbs heat from the electric motor and dissipates heat in a heat exchanger.

In a flying object such as an eVTOL aircraft, it is desired to reduce the size and weight of various components and various systems in order to secure a cruising range. Also in the drive system of the flying object, reduction in size and weight is desired. According to the disclosure of the present specification, it is possible to realize a reduction in size and weight of an electric motor and a motor drive system included in a flying object.

### 1. Flying Object 10

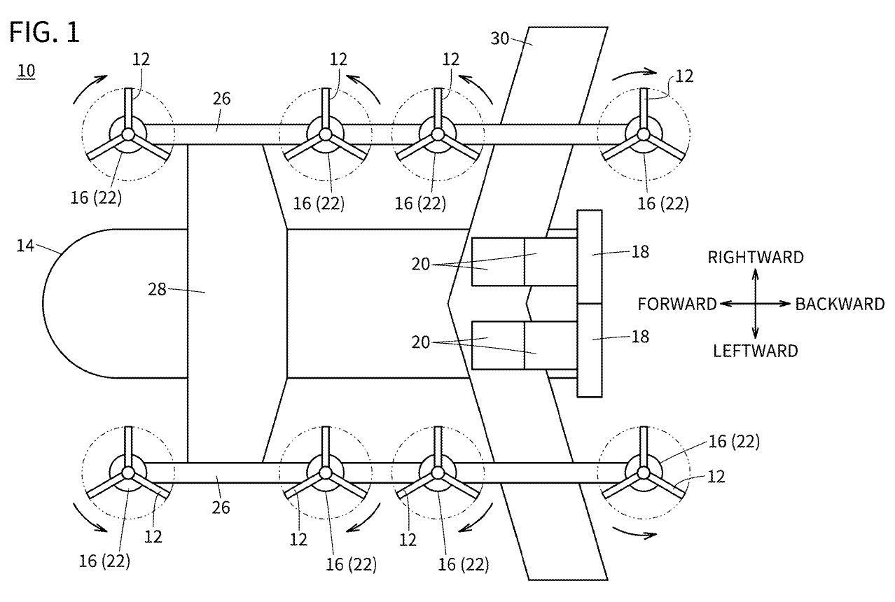

FIG. 1 is a schematic view of a flying object (aerial vehicle) 10. The flying object 10 is an eVTOL aircraft. The flying object 10 includes eight VTOL rotors 12. The VTOL rotor 12 generates thrust upward relative to the airframe 14. The flying object 10 includes eight electric motors 16. One electric motor 16 drives one VTOL rotor 12. The flying object 10 has two cruise rotors 18. The cruise rotor 18 generates thrust forward with respect to the airframe 14. The flying object 10 includes four electric motors 20. Two electric motors 20 drive one cruise rotor 18.

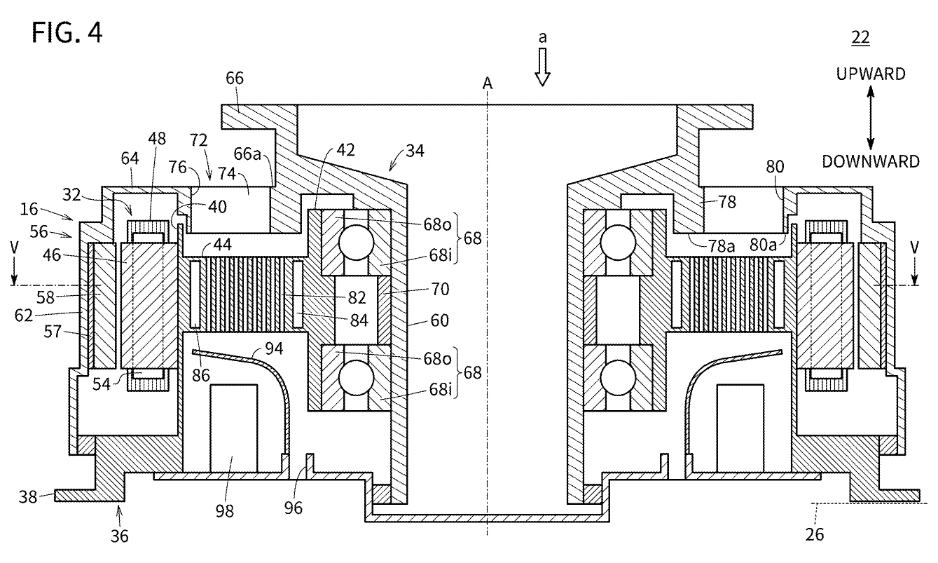

The electric motor 16 that drives the VTOL rotor 12 constitutes a drive unit 22, together with an inverter 98 (FIG. 4) and the like, which will be described later.

The flying object 10 includes a pair of booms 26 extending in the front-rear direction. Each boom 26 is connected to a front wing 28 and a rear wing 30. One of the pair of booms 26 is disposed on the right side of the flying object 10. The other of the pair of booms 26 is disposed on the left side of the flying object 10. Each boom 26 holds four of the drive units 22.

### 2. Drive Unit 22

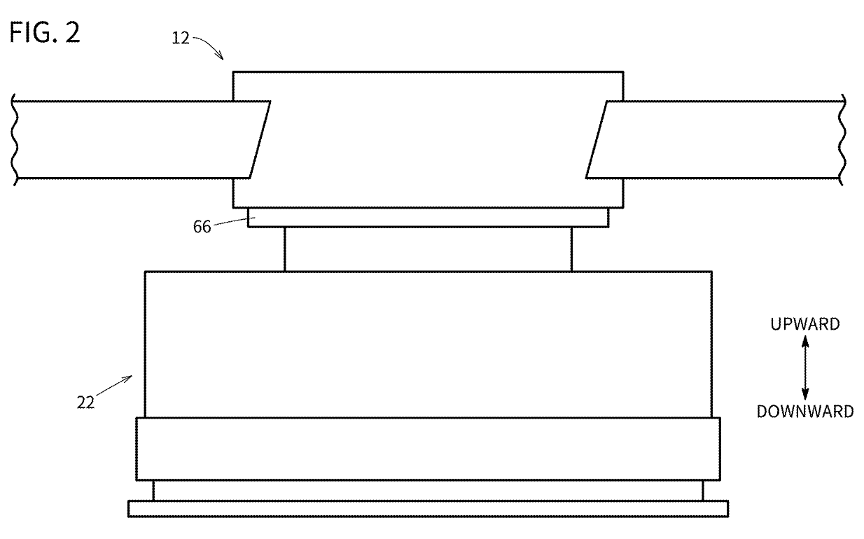

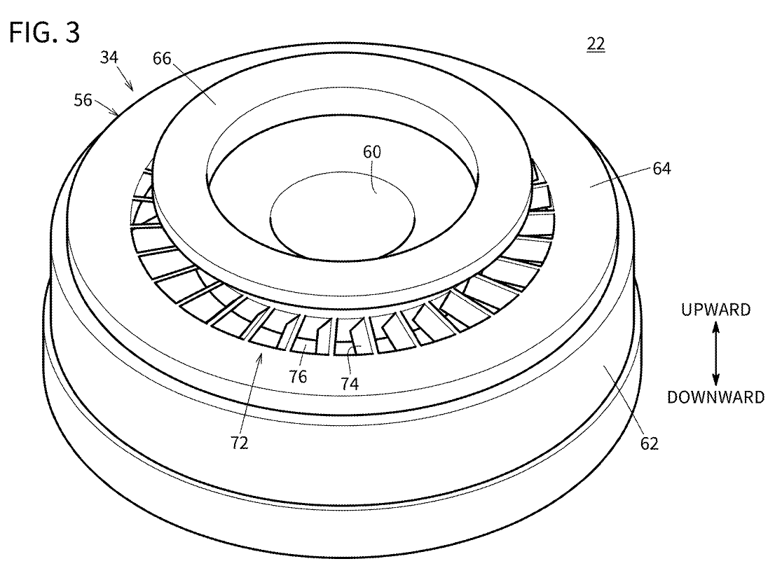

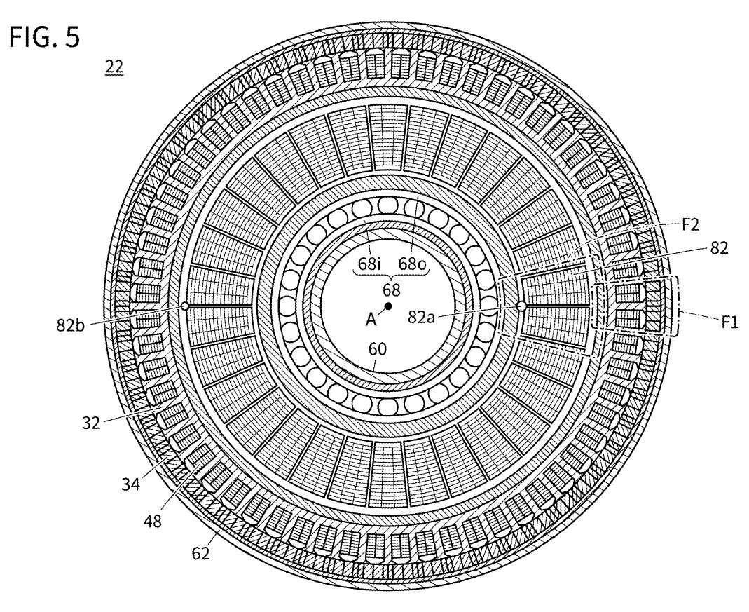

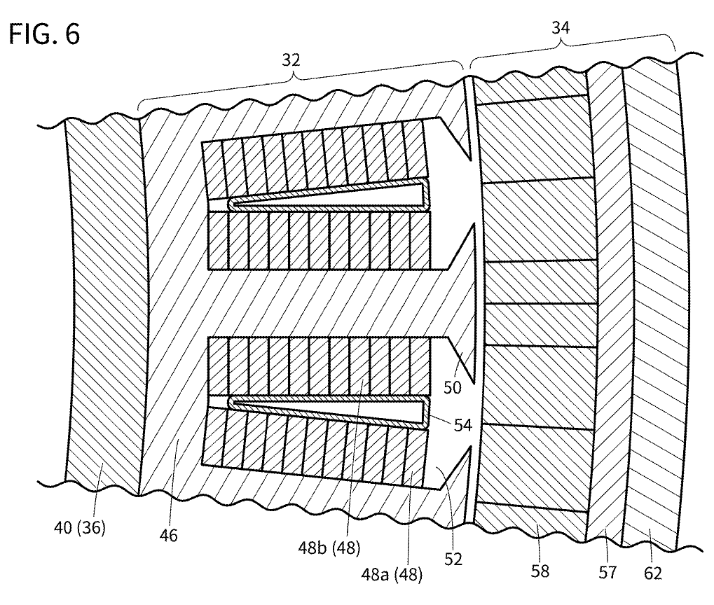

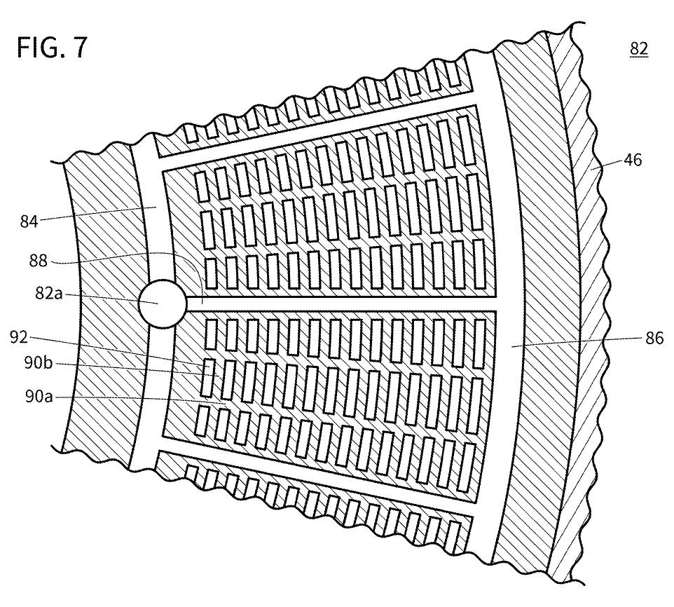

FIG. 2 is a side view of the VTOL rotor 12 and the drive unit 22. FIG. 3 is a perspective view of the drive unit 22. FIG. 4 is a vertical cross-sectional view of the drive unit 22. In FIG. 4, a flow path through which a coolant such as oil flows is omitted. FIG. 5 is a transverse cross-sectional view of the drive unit 22. FIG. 5 shows a cross-section taken along line V-V shown in FIG. 4. FIG. 6 is an enlarged view of a portion within frame F1 in FIG. 5. FIG. 7 is an enlarged view of a portion within frame F2 in FIG. 5.

In the following description, the "radial direction" or “radially” means the radial direction of a circle centered on an axis A of the drive unit 22 (and the electric motor 16). Further, the "circumferential direction" means the circumferential direction of a circle centered on the axis A of the drive unit 22 (and the electric motor 16).

As shown in FIG. 4, the drive unit 22 includes the electric motor 16. The electric motor 16 is an outer rotor type multi-phase alternating-current (AC) motor (for example, a three-phase AC motor). The electric motor 16 includes a motor holding member 36, an annular stator 32, and a rotor 34. The axis A of the drive unit 22, the axis A of the electric motor 16, the axis A of the stator 32, and the axis A of the rotor 34 coincide with each other. The axis A extends along the up-down direction.

### Motor Holding Member 36

As shown in FIG. 4, the motor holding member 36 includes an attachment portion 38, a stator holding portion 40, a rotor holding portion 42, and a connection portion 44. Each of the attachment portion 38, the stator holding portion 40, and the rotor holding portion 42 has a circular-annular shape. The attachment portion 38 is attached to the boom 26. The stator holding portion 40 is connected to an upper portion of the attachment portion 38. The stator holding portion 40 is disposed radially outward of the rotor holding portion 42. The stator 32 is attached to the outer periphery of the stator holding portion 40. The rotor holding portion 42 is disposed radially inward of the stator holding portion 40. An inner cylinder portion 60 of the rotor 34 is attached to the inner periphery of the rotor holding portion 42 via a bearing 68. The connection portion 44 is disposed between the stator holding portion 40 and the rotor holding portion 42. The connection portion 44 connects the stator holding portion 40 and the rotor holding portion 42. The stator holding portion 40, the rotor holding portion 42, and the connection portion 44 function as a heat exchanger 82 described later.

The motor holding member 36 holds the stator 32 and rotatably holds the rotor 34. The stator holding portion 40, the rotor holding portion 42, and the connection portion 44 maintain a position of the rotor 34 relative to the stator 32.

### Stator 32

As shown in FIGS. 5 and 6, the stator 32 includes a stator core 46 and coils 48 of respective phases. The stator core 46 has a substantially circular-cylindrical shape extending along the axis A. The stator core 46 has a plurality of teeth 50 protruding outward in the radial direction. The plurality of teeth 50 are arranged at equal angular intervals along the circumferential direction. A slot 52 is formed between two teeth 50 adjacent to each other. The coil 48 of one of the three phases is wound around each of the teeth 50. In one slot 52, a coil 48a wound around one of two adjacent teeth 50 and a coil 48b wound around the other of the two adjacent teeth 50 are disposed. In one slot 52, a tube (second partial flow path) 54 is disposed along the direction of the axis A between the coil 48a disposed on the one tooth and the coil 48b disposed on the other tooth. A coolant for cooling the coil 48 flows through the tube 54. The inner periphery of the stator core 46 is attached to the stator holding portion 40 of the motor holding member 36. The stator 32 is held by the motor holding member 36. When the coolant is oil, the coil 48 may be directly cooled by filling the slots 52 with oil. In this case, the tube 54 is not necessary.

### Rotor 34

As shown in FIG. 4, the rotor 34 includes a rotor case 56, a rotor core 57, and a plurality of magnets 58. The rotor case 56 includes an inner cylinder portion 60, an outer cylinder portion 62, a connection portion 64, and a VTOL rotor holding portion 66. Each of the inner cylinder portion 60 and the outer cylinder portion 62 has a substantially circular-cylindrical shape along the axis A. The inner cylinder portion 60 is disposed radially inward of the outer cylinder portion 62. The outer cylinder portion 62 is disposed radially outward of the inner cylinder portion 60. The connection portion 64 connects the inner cylinder portion 60 and the outer cylinder portion 62. The VTOL rotor holding portion 66 protrudes upward from the connection portion 64. As shown in FIG. 2, the VTOL rotor 12 is attached to the VTOL rotor holding portion 66. The VTOL rotor holding portion 66 holds the VTOL rotor 12 from below.

As shown in FIGS. 5 and 6, the rotor core 57 having a substantially circular-cylindrical shape is attached to the inner periphery of the outer cylinder portion 62. The plurality of magnets 58 are attached to the inner periphery of the rotor core 57. That is, the outer cylinder portion 62 holds the rotor core 57 and the plurality of magnets 58. The plurality of magnets 58 are arranged so as to surround the outer periphery of the stator 32.

As shown in FIG. 4, the inner cylinder portion 60 is inserted into each of the two bearings 68 and the collar 70. For example, the inner ring (inner race) 68i of each bearing 68 is fitted on the inner cylinder portion 60. A collar 70 is disposed between the two bearings 68. The outer ring (outer race) 68o of each bearing 68 is attached to the rotor holding portion 42 of the motor holding member 36. The inner cylinder portion 60 is held by the motor holding member 36 via the two bearings 68.

As shown in FIGS. 3 and 4, the connection portion 64 is formed with an air-blowing portion 72. In a plan view (as viewed in the direction of the arrows a in FIG. 4), the air-blowing portion 72 is formed radially outward of the base end portion 66a of the VTOL rotor holding portion 66. The air-blowing portion 72 includes a plurality of fan blades 74. The plurality of fan blades 74 are arranged along the circumferential direction. A gap 76 through which outside air can pass is formed between two adjacent fan blades 74. The plurality of fan blades 74 supply air to the heat exchanger 82 located below as the rotor 34 rotates.

As shown in FIG. 4, the connection portion 64 includes an annular protrusion (first protrusion) 78 protruding toward the heat exchanger 82 located below, and an annular protrusion (second protrusion) 80 protruding toward the heat exchanger 82. In a plan view (as viewed in the direction indicated by the arrow a in FIG. 4), the protruding end 78a of the protrusion 78 is disposed radially inward of the air-blowing portion 72 and radially outward of the rotor holding portion 42. In other words, in a plan view (as viewed in the direction indicated by the arrow a in FIG. 4), the rotor holding portion 42 is disposed radially inward of the protruding end 78a of the protrusion 78. The protruding end 78a of the protrusion 78 overlaps the rotor holding portion 42 in a side view. On the other hand, in a plan view (as viewed in the direction indicated by the arrow a in FIG. 4), the protruding end 80a of the protrusion 80 is disposed radially outward of the air-blowing portion 72 and radially inward of the stator holding portion 40. In other words, in a plan view (as viewed in the direction of the arrow a in FIG. 4), the stator holding portion 40 is disposed radially outward of the protruding end 80a of the protrusion 80. The protruding end 80a of the protrusion 80 overlaps the stator holding portion 40 in a side view.

The protrusion 78, the protrusion 80, the rotor holding portion 42, and the stator holding portion 40 function as a guide for outside air blown from the fan blades 74 to the heat exchanger 82. According to this structure, it is possible to suppress leakage of the outside air from the outside air introduction path extending from the fan blades 74 to the heat exchanger 82.

### Heat Exchanger 82

As shown in FIG. 4, the electric motor 16 includes the heat exchanger 82 having a circular-annular shape (circular-cylindrical shape). The heat exchanger 82 is also referred to as a radiator. The heat exchanger 82 is formed integrally with the motor holding member 36. The heat exchanger 82 and the motor holding member 36 may be integrally molded, or a component constituting the heat exchanger 82 and a component constituting the motor holding member 36 may be coupled to each other by a bolt, a rivet, or the like. As described above, the heat exchanger 82 constitutes the stator holding portion 40, the rotor holding portion 42, and the connection portion 44 of the motor holding member 36. The heat exchanger 82 is disposed between the stator 32 and the bearings 68 (and the inner cylinder portion 60) of the rotor 34. The heat exchanger 82 connects the stator 32 and the bearings 68.

In this way, the heat exchanger 82 also functions as the stator holding portion 40, the rotor holding portion 42, and the connection portion 44 of the motor holding member 36. According to this structure, since it is not necessary to separately provide the heat exchanger 82 and the connection portion 44 (and the stator holding portion 40 and the rotor holding portion 42), the number of components of the drive unit 22 is reduced. That is, according to this structure, the drive unit 22 can be reduced in weight and size.

As shown in FIG. 7, an inner annular flow passage 84, an outer annular flow passage 86, and a plurality of radial flow passages 88 are formed inside the heat exchanger 82. The inner annular flow passage 84 is an annular flow passage formed on the inner peripheral side of the heat exchanger 82. The inner annular flow passage 84 defines a supply port 82a, which is an inlet for coolant to the heat exchanger 82. The outer annular flow passage 86 is an annular flow passage formed on the outer peripheral side of the heat exchanger 82. The outer annular flow passage 86 defines a discharge port 82b (FIG. 5), which is an outlet for coolant from the heat exchanger 82. Each of the radial flow passages 88 is a flow passage extending from the inner annular flow passage 84 to the outer annular flow passage 86 along the radial direction. The plurality of radial flow passages 88 are arranged at equal angular intervals along the circumferential direction of the heat exchanger 82. Each radial flow passage 88 provides communication between the inner annular flow passage 84 and the outer annular flow passage 86.

A plurality of heat-dissipating fins 90a along the radial direction and a plurality of heat-dissipating fins 90b along the circumferential direction are disposed between the inner annular flow passage 84 and the outer annular flow passage 86. Further, a plurality of air flow passages 92 are formed between the inner annular flow passage 84 and the outer annular flow passage 86. The air flow passages 92 penetrate the motor holding member 36 along the axis A.

### Air Guide Plate 94

As shown in FIG. 4, the drive unit 22 includes an air guide plate 94. The air guide plate 94 is disposed below the heat exchanger 82. The air guide plate 94 is connected to an exhaust port 96 that opens downward of the drive unit 22. The air guide plate 94 guides outside air that has passed through the air flow passage 92 of the heat exchanger 82 to the exhaust port 96.

### Inverter 98

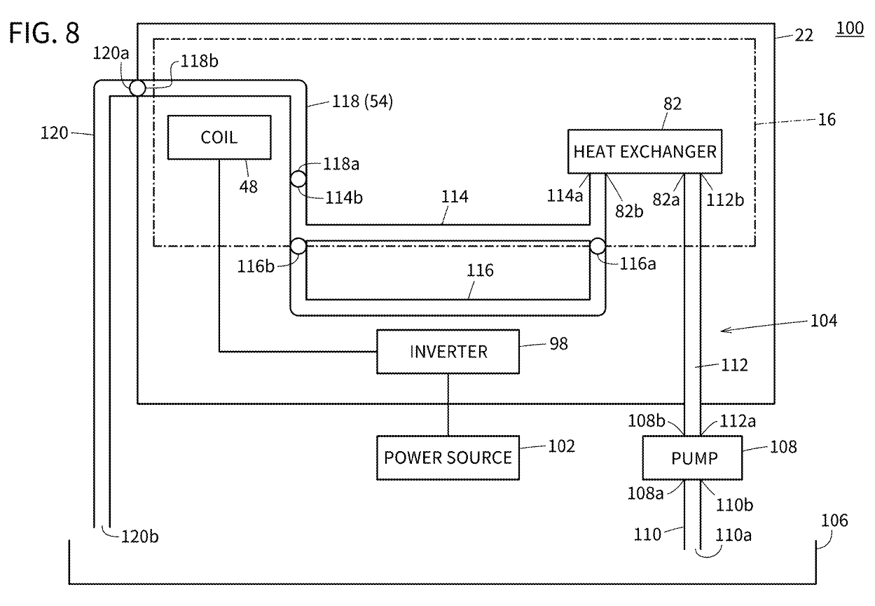

As shown in FIG. 4, the drive unit 22 includes an inverter 98. The inverter 98 converts direct-current (DC) power supplied from a power source 102 (FIG. 8) into alternating-current (AC) power and supplies the AC power to the coil 48. The inverter 98 is disposed below the heat exchanger 82. The air guide plate 94 is interposed between the heat exchanger 82 and the inverter 98. In a plan view (as viewed in the direction of the arrow a in FIG. 4), the inverter 98 is disposed inward of the stator 32 and the stator holding portion 40 and outward of the rotor 34, the bearings 68, and the rotor holding portion 42. By disposing the inverter 98 in a dead space (i.e., an unused space in which no components or the like are provided) in this manner, the drive unit 22 can be reduced in size.

### Motor Drive System 100

FIG. 8 is a system configuration diagram of the motor drive system 100. The motor drive system 100 includes the power source 102, the inverter 98, and the electric motor 16. The power source 102 supplies electric power to the coil 48 of the electric motor 16 via the inverter 98.

The motor drive system 100 includes a cooling circuit 104. The cooling circuit 104 circulates coolant. The cooling circuit 104 includes a tank 106, a pump 108 and a plurality of partial flow paths 110, 112, 114, 116, 118, 120.

The upstream end 110a of the partial flow path 110 is connected to the tank 106. The downstream end 110b of the partial flow path 110 is connected to the suction port 108a of the pump 108. The upstream end 112a of the partial flow path 112 is connected to the discharge port 108b of the pump 108. The downstream end 112b of the partial flow path 112 is connected to the supply port 82a of the heat exchanger 82. The upstream end 114a of the partial flow path 114 is connected to the discharge port 82b of the heat exchanger 82. The downstream end 114b of the partial flow path 114 is connected to the upstream end 118a of the partial flow path 118. The upstream end 116a of the partial flow path (first partial flow path) 116 is connected to an upstream portion of the partial flow path 114. The downstream end 116b of the partial flow path 116 is connected to a downstream portion of the partial flow path 114. The upstream end 118a of the partial flow path (second partial flow path) 118 is connected to the downstream end 114b of the partial flow path 114. The downstream end 118b of the partial flow path 118 is connected to the upstream end 120a of the partial flow path 120. The upstream end 120a of the partial flow path 120 is connected to the downstream end 118b of the partial flow path 118. The downstream end 120b of the partial flow path 120 is connected to the tank 106.

The partial flow path 116 is disposed along the circuit board (not shown) of the inverter 98. Thus, the inverter 98 is cooled by coolant. The partial flow path 118 is disposed along the coil 48. The partial flow path 118 corresponds to the tube 54 shown in FIGS. 4 and 6. Thus, the coil 48 is cooled by coolant. Since the control temperature of the coil 48 is higher than the control temperature of the inverter 98, the temperature of the coil 48 is higher than the temperature of the inverter 98. Therefore, in the cooling circuit 104, the partial flow path 116 is disposed on the upstream side, and the partial flow path 118 is disposed on the downstream side.

### 3. Operation of Drive Unit 22 and Motor Drive System 100

The flow of outside air will be described with reference to FIG. 4. The power source 102 shown in FIG. 8 supplies electric power to the electric motor 16 via the inverter 98. The rotor 34 is rotated by periodically energizing the coils 48 of the respective phases. As the rotor 34 rotates, each fan blade 74 of the air-blowing portion 72 blows outside air to the heat exchanger 82. Outside air passes through the air flow passage 92 (FIG. 7) of the heat exchanger 82, flows along the air guide plate 94, and is discharged through the exhaust port 96 to the outside of the drive unit 22.

The flow of coolant will be described with reference to FIG. 8. The pump 108 draws in coolant from the tank 106 via the partial flow path 110, and discharges the coolant to the partial flow path 112. The coolant flows through the partial flow path 112 and flows into the heat exchanger 82. In the heat exchanger 82, the coolant flows through the inner annular flow passage 84, the radial flow passages 88, and the outer annular flow passage 86 shown in FIG. 7, and is then discharged from the heat exchanger 82. In the heat exchanger 82, the coolant dissipates heat to outside air passing through the air flow passage 92, via the heat-dissipating fins 90a and the heat-dissipating fins 90b. The coolant discharged from the heat exchanger 82 flows through the partial flow path 114, the partial flow path 116, the partial flow path 118, and the partial flow path 120, and then returns to the tank 106. In the partial flow path 116, the coolant absorbs heat from the inverter 98. In the partial flow path 118 (tube 54), the coolant absorbs heat from the coils 48. In this way, the coolant absorbs heat from the inverter 98 and the coils 48, and dissipates heat to outside air in the heat exchanger 82.

### 4. Supplementary Notes

The following Supplementary Notes are further disclosed in relation to the above embodiments.

### Supplementary Note 1

The electric motor (16) of the present disclosure includes the stator (32) having an annular shape and including the coil (48); the rotor (34) including the plurality of magnets (58) arranged to surround the outer periphery of the stator, the outer cylinder portion (62) that holds the plurality of magnets, and the inner cylinder portion (60) located inward of the stator; and the heat exchanger (82) configured to exchange heat between outside air and coolant that cools the coil of the stator, wherein the heat exchanger is disposed between the stator and the inner cylinder portion of the rotor.

With the above configuration, the drive unit including the electric motor can be reduced in weight and size.

### Supplementary Note 2

The electric motor according to Supplementary Note 1 may further include the bearing (68) attached to the outer periphery of the inner cylinder portion of the rotor, and the heat exchanger may connect the stator and the bearing.

### Supplementary Note 3

In the electric motor according to Supplementary Note 2, the rotor may include the connection portion (64) that connects the inner cylinder portion and the outer cylinder portion, and the connection portion may include the plurality of fan blades (74) arranged along the circumferential direction of the rotor, the fan blades being configured to blow air to the heat exchanger as the rotor rotates.

### Supplementary Note 4

In the electric motor according to Supplementary Note 3, the connection portion may include the first protrusion (78) having an annular shape and the second protrusion (80) having an annular shape, the first protrusion protruding toward the heat exchanger, the second protrusion protruding toward the heat exchanger, the heat exchanger may include the stator holding portion (40) having an annular shape and the rotor holding portion (42) having an annular shape, the stator holding portion holding the stator, the rotor holding portion holding the rotor, the protruding end (78a) of the first protrusion may be disposed radially inward of the plurality of fan blades in plan view, the rotor holding portion may be disposed radially inward of the protruding end of the first protrusion in plan view, the protruding end of the first protrusion may overlap the rotor holding portion in side view, the protruding end (80a) of the second protrusion may be disposed radially outward of the plurality of fan blades in plan view, the stator holding portion may be disposed radially outward of the protruding end of the second protrusion in plan view, and the protruding end of the second protrusion may overlap the stator holding portion in side view.

With the above configuration, it is possible to suppress leakage of outside air from the outside air introduction path extending from the fan blade to the heat exchanger.

### Supplementary Note 5

The motor drive system (100) of the present disclosure includes: the electric motor according to any one of Supplementary Notes 1 to 4; the inverter (98) configured to convert direct-current power supplied from the power source (102) into alternating-current power and supply the alternating-current power to the coil; the first partial flow path (116), wherein the coolant that has passed through the heat exchanger flows through the first partial flow path to thereby cool the inverter; and the second partial flow path (118), wherein the coolant that has passed through the first partial flow path flows through the second partial flow path to thereby cool the coil of the stator.

### Supplementary Note 6

In the motor drive system according to Supplementary Note 5, the inverter may be disposed inward of the stator in plan view.

With the above configuration, the drive unit including the electric motor can be reduced in size.

Although the present disclosure has been described in detail, the present disclosure is not limited to the above-described embodiments. In these embodiments, various additions, replacement, changing, partial deletion, and the like can be made without departing from the essence and gist of the present disclosure or without departing from the essence and gist of the

present disclosure derived from the contents described in the claims and equivalents thereof. Further, the embodiments can also be implemented together in combination. For example, in the above-described embodiments, the order of each of the operations and the order of each of the processes are illustrated as examples, and the present invention is not necessarily limited to these features. The same applies also in the case that numerical values or mathematical equations are used in the description of the aforementioned embodiments.

1. An electric motor comprising:
a stator having an annular shape and including a coil;
a rotor including a plurality of magnets arranged to surround an outer periphery of the stator, an outer cylinder portion that holds the plurality of magnets, and an inner cylinder portion located inward of the stator; and
a heat exchanger configured to exchange heat between outside air and coolant that cools the coil of the stator,
wherein the heat exchanger is disposed between the stator and the inner cylinder portion of the rotor.

2. The electric motor according to claim 1, further comprising:
a bearing attached to an outer periphery of the inner cylinder portion of the rotor,
wherein the heat exchanger connects the stator and the bearing.

3. The electric motor according to claim 2, wherein
the rotor includes a connection portion that connects the inner cylinder portion and the outer cylinder portion, and
the connection portion includes a plurality of fan blades arranged along a circumferential direction of the rotor, the fan blades being configured to blow air to the heat exchanger as the rotor rotates.

4. The electric motor according to claim 3, wherein
the connection portion includes a first protrusion having an annular shape and a second protrusion having an annular shape, the first protrusion protruding toward the heat exchanger, the second protrusion protruding toward the heat exchanger,
the heat exchanger includes a stator holding portion having an annular shape and a rotor holding portion having an annular shape, the stator holding portion being configured to hold the stator, the rotor holding portion being configured to hold the rotor,
a protruding end of the first protrusion is disposed radially inward of the plurality of fan blades in plan view,
the rotor holding portion is disposed radially inward of the protruding end of the first protrusion in plan view,
the protruding end of the first protrusion overlaps the rotor holding portion in side view,
a protruding end of the second protrusion is disposed radially outward of the plurality of fan blades in plan view,
the stator holding portion is disposed radially outward of the protruding end of the second protrusion in plan view, and
the protruding end of the second protrusion overlaps the stator holding portion in side view.

5. A motor drive system comprising:
the electric motor according to claim 1;
an inverter configured to convert direct-current power supplied from a power source into alternating-current power and supply the alternating-current power to the coil of the stator;
a first partial flow path, wherein the coolant that has passed through the heat exchanger flows through the first partial flow path to thereby cool the inverter; and
a second partial flow path, wherein the coolant that has passed through the first partial flow path flows through the second partial flow path to thereby cool the coil of the stator.

6. The motor drive system according to claim 5, wherein
the inverter is disposed inward of the stator in plan view.
